(19) United States
(12) Patent Application Publication
(10) Pub. No.: US 2023/0308932 A1
(43) Pub. Date: Sep. 28, 2023

(54) Design for XR Traffic Information Indication

(71) Applicant: Apple Inc., Cupertino, CA (US)

(72) Inventors: Weidong Yang, San Diego, CA (US); Dawei Zhang, Saratoga, CA (US); Huaning Niu, San Jose, CA (US); Hong He, Cupertino, CA (US); Oghenekome Oteri, San Diego, CA (US); Chunxuan Ye, San Diego, CA (US); Haitong Sun, Cupertino, CA (US); Sigen Ye, San Diego, CA (US); Wei Zeng, San Diego, CA (US)

(21) Appl. No.: 17/989,424

(22) Filed: Nov. 17, 2022

Related U.S. Application Data
(60) Provisional application No. 63/303,455, filed on Jan. 26, 2022.

(51) Int. Cl. H04W 28/02; H04W 28/08

(52) U.S. Cl. CPC H04W 28/0263; H04W 28/0268; H04W 28/0858

(57) ABSTRACT

Methods, apparatuses, and systems are disclosed for providing traffic information pertaining to a data traffic group, e.g., for use in 3GPP XR communications. A UE may transmit a traffic flow including data of a certain type (e.g., video, audio, control/pose) generated by an application implemented on the UE, such as an augmented reality application. The traffic flow may include bursts of data traffic groups, wherein each group includes a plurality of data packets containing a functional set of data, such as data for encoding a single video frame. A UE may generate and transmit, to a base station, traffic information regarding the nature, status, performance, and/or constraints of the data traffic group. The base station may use the traffic information to make intelligent scheduling decisions regarding the data traffic group.

### PRIORITY INFORMATION

This application claims priority to U.S. Provisional Pat. Application Serial No. 63/303,455, entitled “Design for XR Traffic Information Indication,” filed Jan. 26, 2022, which is hereby incorporated by reference in its entirety as though fully and completely set forth herein.

### FIELD

The present application relates to wireless communications, and more particularly to systems, apparatuses, and methods for providing information to support data traffic groups in cellular communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, virtual reality, augmented reality, cloud gaming, and navigation using the global positioning system (GPS), and are capable of operating sophisticated applications that utilize these and other functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™ (BT), etc.

The ever-increasing number of features and functionality introduced in wireless communication devices also creates a continuous need for improvement in both wireless communications and in wireless communication devices. In particular, as UE devices improve to support specialized communication-intensive application capabilities, such as virtual reality and augmented reality capabilities, UEs and networks may require new procedures for managing specialized data flows in the network. Accordingly, improvements in the field are desired.

### SUMMARY

Embodiments are presented herein of apparatuses, systems, and methods for providing to a base station traffic information pertaining to a data traffic group of a traffic flow.

For example, a UE may transmit a traffic flow including data of a certain type (e.g., video, audio, control/pose) generated by an application implemented on the UE, such as an augmented reality application. The traffic flow may include bursts of data traffic groups, wherein each group includes a plurality of data packets containing a functional set of data, such as data for encoding a single video frame. A UE may generate and transmit, to a base station, traffic information regarding the nature, status, performance, and/or constraints of the data traffic group. The base station may use the traffic information to make intelligent scheduling decisions regarding the data traffic group.

A method is disclosed, which may be executed by a user equipment (UE). The UE may generate traffic information pertaining to a data traffic group including data from an application being executed on the UE; and transmit the traffic information to a base station.

In some scenarios, the UE may transmit the data traffic group, including a plurality of packets including at least a minimum quantity of data needed for the application to perform a single function.

In some scenarios, the minimum quantity of data may constitute a minimum quantity of video data needed for the application to encode a discrete portion of a video frame.

In some scenarios, transmitting the traffic information may include including the traffic information within a medium access control (MAC) control element (CE) within a physical uplink shared channel (PUSCH).

In some scenarios, the traffic information may include latency information to be measured from a reference time, wherein the reference time used is the start of a symbol in which begins a physical uplink shared channel (PUSCH) in which the traffic information is transmitted.

In some scenarios, generating the traffic information may include generating at least one uplink control information (UCI) including the traffic information.

In some such scenarios, transmitting the traffic information may include including the UCI including the traffic information within a physical uplink control channel (PUCCH). The PUCCH may further include at least one additional UCI.

In some such scenarios, the at least one additional UCI may include traffic information pertaining to a second data traffic group including a different class of data from the application. In some scenarios, a portion of the traffic information may be omitted from the UCI and the at least one additional UCI, due to insufficient resources within the PUCCH to include all available UCIs.

In some scenarios, at least one additional UCI may be omitted from the PUCCH due to insufficient resources within the PUCCH to include all available UCIs.

In some scenarios, the at least one additional UCI may selected for omission based on a priority index included in the traffic information. In some scenarios, the UCI omitted may be selected based on a relative priority level of the UCI type.

In some scenarios, the traffic information may include latency information to be measured from a reference time, wherein the reference time used is the start of a symbol in which begins a physical uplink control channel (PUCCH) in which the traffic information is transmitted.

In some scenarios, the traffic information may include latency information to be measured from a reference time, wherein the reference time used is the start of a slot in which the traffic information is transmitted.

In some scenarios, the traffic information may include at least one of: a reliability requirement of the data traffic group; a priority level of the data traffic group; a maximum group error rate of the data traffic group; a number of remaining packets in the data traffic group; packet size of one or more packets of the data traffic group; or packet size of remaining packets in the data traffic group.

In some scenarios, the UE may receive, from the base station, an indication to provide traffic information regarding a particular traffic flow, wherein the data traffic group is included in the particular traffic flow, and wherein the generating the traffic information is in response to receiving the indication.

In some such scenarios, the indication may further indicate periodic resources for the UE to provide traffic information regarding the particular traffic flow.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 illustrates an example of communication traffic including a plurality of bursts, each burst including one or more data traffic groups, according to some embodiments;

FIG. 6 illustrates an example of two PUSCH transmissions occurring at different positions within two respective slots, according to some embodiments;

FIG. 7 illustrates an example of two PUCCH transmissions occurring at different positions within two respective slots, according to some embodiments;

FIG. 8 illustrates a block diagram representing multiplexing of a plurality of UCIs, according to some embodiments;

FIG. 9 illustrates an example of multiplexing a UCI for traffic information with a UCI for HARQ-ACK within a PUCCH, according to some embodiments;

FIG. 10 illustrates an example of multiplexing a UCI for traffic information with a UCI for HARQ-ACK within a PUSCH, according to some embodiments;

FIGS. 11A, 11B, 11C, 11D, 12A, 12B, 13A, 13B, 13C, 13D, 13E, 14A, and 14B illustrate block diagrams representing various configurations by which a UCI carrying traffic information pertaining to one or more data groups may be multiplexed with one or more other UCI(s) for transport on a PUCCH, according to some embodiments;

FIGS. 15A, 15B, 15C, 15D, 16A, 16B, 16C, 16D, 16E, 17A, 17B, 17C, 17D, 17E, 17F, 18A, 18B, 18C, 18D, and 18E illustrate block diagrams representing various configurations by which a UCI carrying traffic information pertaining to one or more data groups may be multiplexed with one or more other UCI(s) for transport on a PUSCH, according to some embodiments; and

FIG. 19 is a flow chart diagram illustrating a method for providing traffic information pertaining to a data traffic group, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
ADU: Application Data Unit
CSI: Channel State Information
DCI: Downlink Control Information
EUTRA: Evolved UMTS Terrestrial Radio Access
GSM: Global System for Mobile Communication
LTE: Long Term Evolution
MAC: Medium Access Control
MAC CE: MAC Control Element
NR: New Radio
PDCCH: Physical Downlink Control Channel
PDSCH: Physical Downlink Shared Channel
PUCCH: Physical Uplink Control Channel
PUSCH: Physical Uplink Shared Channel
RAT: Radio Access Technology
RF: Radio Frequency
RSRP: Reference Signal Received Power
RSRQ: Reference Signal Received Quality
RX: Reception/Receive
SP: Semi-Persistent
TX: Transmission/Transmit
UCI: Uplink Control Information
UE: User Equipment
UMTS: Universal Mobile Telecommunication System
XR: Extended Reality

### Terms

The following is a glossary of terms that may appear in the present disclosure:

Memory Medium – Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium – a memory medium as described above, as well as a physical transmission medium, such as a bus, network, and/or other physical transmission medium that conveys signals such as electrical, electromagnetic, or digital signals.

Computer System (or Computer) – any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”) – any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), virtual/augmented reality devices, etc. In general, the term “UE” or “UE device” can be broadly defined to encompass any electronic, computing, and/or telecommunications device (or combination of devices) which is easily transported by a user and capable of wireless communication.

Wireless Device – any of various types of computer systems or devices that perform wireless communications. A wireless device can be portable (or mobile) or may be stationary or fixed at a certain location. A UE is an example of a wireless device.

Communication Device – any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS) – The term “Base Station” has the full breadth of its ordinary meaning, and at least includes a wireless communication station installed at a fixed location and used to communicate as part of a wireless telephone system or radio system.

Processing Element (or Processor) – refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi – The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically – refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to – Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

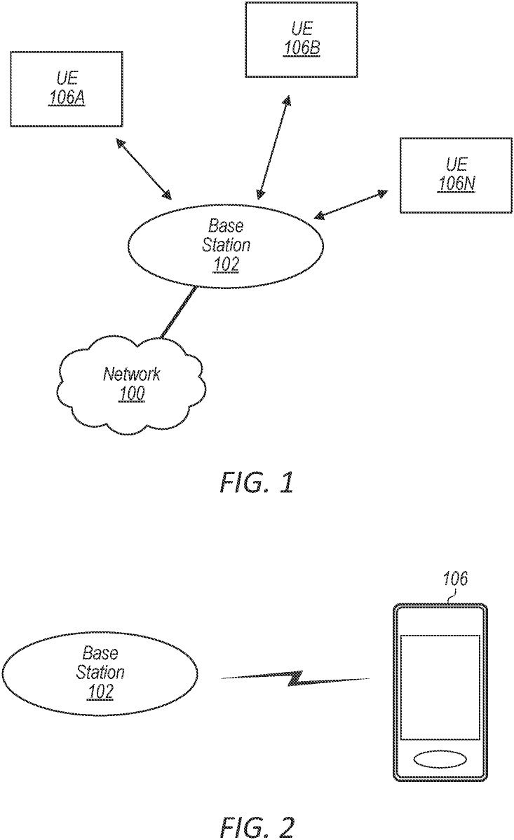

### FIGS. 1 and 2 - Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an “eNodeB” or “eNB”. If the base station 102 is implemented in the context of 5G NR, it may alternately be referred to as a “gNodeB” or “gNB”. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1xRTT, 1xEV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to provide and/or utilize information to support data traffic groups, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, a virtual/augmented reality device, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1xRTT (or LTE or NR, or LTE or GSM), and separate radios for communicating using each of Wi-Fi and BLUETOOTH™. Other configurations are also possible.

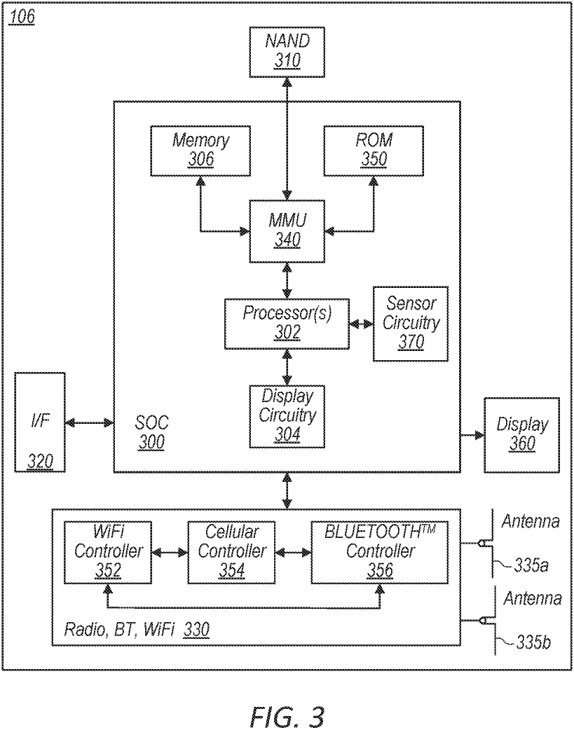

### FIG. 3 -Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. In some implementations, the display 360 may include a touchscreen capable of detecting user input, e.g., as touch events. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector interface (I/F) 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to provide and/or utilize information to support data traffic groups, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to provide and/or utilize information to support data traffic groups according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE, LTE-A, and/or NR controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

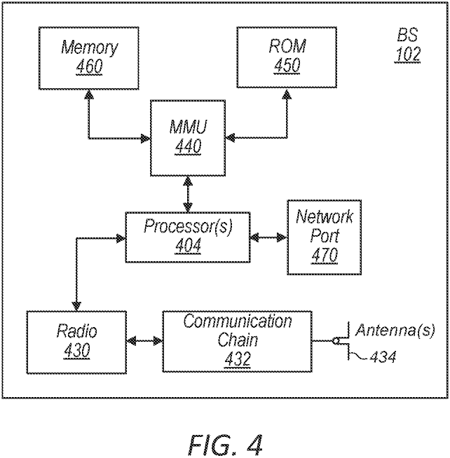

### FIG. 4 -Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE device 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

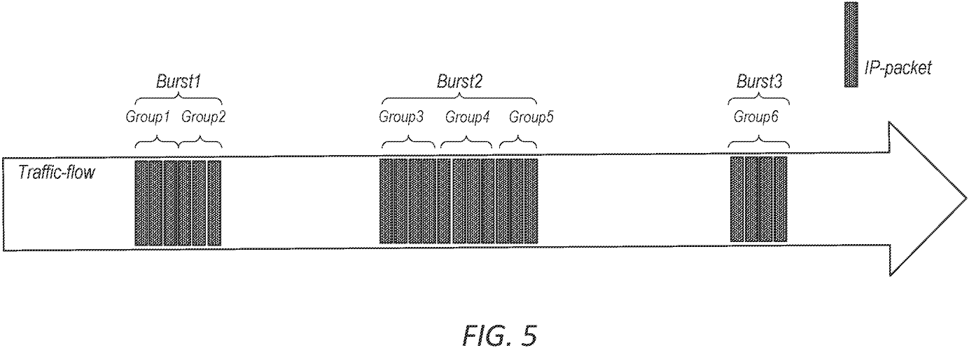

### FIG. 5 – Data Traffic Groups for XR Traffic

Virtual reality (VR), as well as similar augmented reality (AR) and/or mixed reality (MR), applications can be processor intensive, as they may involve real-time video processing, audio processing, location/position processing, environment processing, haptic feedback processing, etc. Such intensive processing may be beyond the processing and/or battery power capabilities of many mobile user devices. Extended reality (XR) support currently being considered by 3GPP represents an attempt to mitigate these challenges by offloading significant processing functions to one or more network devices, such as an XR server, e.g., in a NR network, while providing time-critical communications to exchange associated data between the network and a UE that is providing the user interface. Cloud gaming applications may function similarly.

For example, in some scenarios, uplink and/or downlink XR application traffic may include video information and/or scene information. Although such data may be formatted as IP packets for wireless transmission (e.g., according to 5G/IETF/industry fora communication protocols), a single IP packet may be insufficient to carry a functional quantity of data; e.g., a minimum functional quantity of data. For example, several packets may be required in order to provide a complete video frame, or a quantum subdivision of a video frame. A video encoder receiving the IP packets may consume the data from the several packets together to perform a single function, such as to encode the complete video frame or a discrete portion thereof, such as a subdivision of a video frame. Therefore, the several packets carrying data for a single function, application process, etc., may be grouped as a single functional data traffic group, such as an application data unit (ADU). Such a data traffic group may include a number of packets sufficient to provide the functional quantity of data, e.g., a minimum functional quantity of data needed to perform the single function, application process, etc.

In some scenarios, multiple data streams may be transmitted, e.g., to communicate multiple data types. For example, a first data stream may include data traffic groups containing video data, a second data stream may include data traffic groups containing audio data, and a third data stream may include data traffic groups containing location/position data. As another example, a data stream may be associated with data traffic groups including heterogeneous data such as audio data, video data, etc.

XR traffic may include bursts of traffic that carry one or more data traffic groups. FIG. 5 illustrates an example of communication traffic including a plurality of bursts, each burst including one or more data traffic groups, according to some embodiments. As illustrated, the communication traffic of FIG. 5 includes three traffic bursts. In some scenarios, each burst may represent a capture of a virtual world, and may include any appropriate data, such as audio, video, environment data, location/position data, sensor data, haptic feedback data, etc.

As illustrated, Burst1 includes two data traffic groups: Group1 and Group2. Each of Group1 and Group2 includes three IP packets. As one example, Burst1 may include IP packets for encoding a video frame, wherein Group1 may include three IP packets carrying data to encode a first renderable subdivision of the video frame (e.g., a top region of the frame) and Group2 may include three IP packets carrying data to encode a second renderable subdivision of the video frame (e.g., a bottom region of the frame). In this example, the receiving video encoder may be capable of rendering the top region of the frame upon successfully receiving Group1 and may be capable of rendering the bottom region of the frame upon successfully receiving Group2.

As illustrated, Burst2 includes three data traffic groups. Group3 and Group4 each include four IP packets, which may carry data of a different type than the data carried in Group1 and Group2. E.g., Group3 and/or Group4 may carry audio data, environment data, location/position data, etc. Group5 includes three IP packets, and may be of the same type as Group1 and Group2, or may be a different type.

As illustrated, Burst3 includes only Group6, which includes 4 IP packets. Group6 may be of the same type as Group3 and Group4, or may be a different type.

In some scenarios, various performance parameters, such as error rate, latency information, relative packet type importance, etc., may be specified at the data traffic group level rather than (or in addition to) the packet level, so as to better capture application requirements. As a first example, an application may have a certain group error rate (GER) requirement. The GER may be expressed as a percentage of data traffic groups in error in a specific measurement window. For example, in some scenarios, wherein a data traffic group includes a minimum quantity of data that may be meaningfully consumed by the receiving device, failure of any single packet within a data traffic group may result in failure of the data traffic group as a whole. Thus, communications may fail to meet a specified GER requirement, even if a packet error rate (PER) requirement specified by the network is met.

As a second example, an application may have a certain latency requirement for a data traffic group. Such a latency requirement may specify a maximum time allowed to receive all packets in a data traffic group, measured from the time the first packet is transmitted. In some scenarios, e.g., in which the receiving device is unable to utilize the received data without receiving all packets of the data traffic group, if a base station recognizes that insufficient time remains to meet the data traffic group latency requirement, then the base station may forego transmission of the remaining packets of the data traffic group in downlink (or may forego allocating resources for a UE to transmit the remaining packets in uplink), as the receiving device may be unable to utilize the data of the data traffic group if any packets of the data traffic group are not received.

As a third example, one or more packets of a data traffic group may be specified as more or less important than other packets. For example, if a data-generating application implements an application-level error correction, then the application client may only consume a certain fraction of the bits of a data traffic group, and the remaining bits may be omitted to improve capacity. If an application implements error concealment techniques, then it may be tolerant to a certain percentage of bits of a data traffic group in error. Certain video encoder configurations can consume all bits of a data traffic group up to the first bit in error, and all subsequent bits after the first bit in error can be discarded, since it cannot be consumed by the corresponding decoder.

Alternatively, packets within a data traffic group may include distinct varieties of data. For example, a first packet of a video data traffic group may include data for encoding an I-slice (intra-coded slice) of a first frame, which may be independently encodable/decodable, while a second packet of the data traffic group may include data for encoding a P-slice (predicted slice) of a second frame, which may be encodable as a function of differences relative to the preceding I-slice. In such a scenario, the receiving device may be capable of implementing an error handling procedure to recover from a missed P-slice. However, missing an I-slice may render subsequent P-slices unusable. Thus, the packet containing the I-slice may be specified to have a higher importance than the packet containing the P-slice. If the base station determines that the packet containing the I-slice was not successfully received, then the base station may forego transmission of the remaining packets of the data traffic group in downlink (or may forego allocating resources for a UE to transmit the remaining packets in uplink).

In some scenarios, these various data traffic group performance parameters may differ for various data types. For example, a first latency requirement and/or GER may be set for data traffic groups containing video data, and a second latency requirement and/or GER may be set for data traffic groups containing audio data.

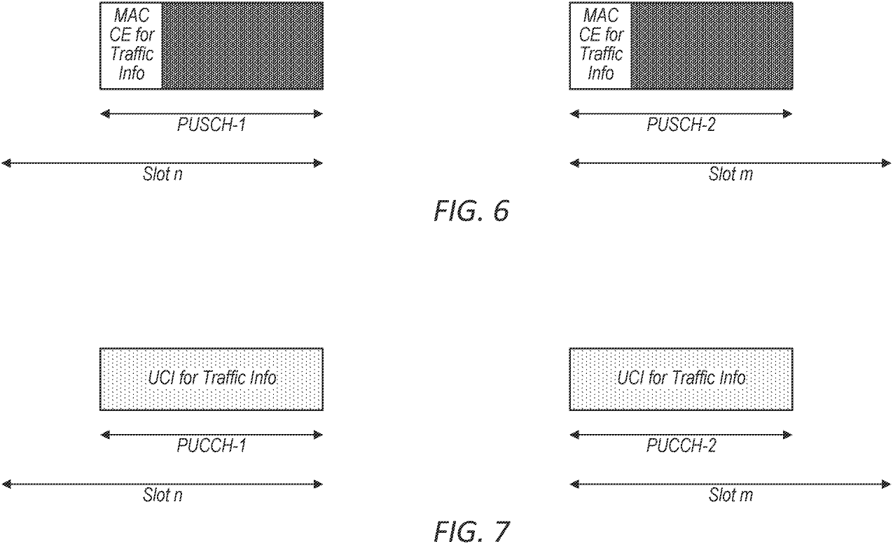

### FIGS. 6-7 – Data Group Traffic Information

From the perspective of the base station, handling of data traffic groups occurs at the MAC and PHY layers. The base station may therefore be unaware of various higher-layer considerations, such as those discussed above, which may affect data traffic group performance. Therefore, the UE may provide feedback to the base station to indicate various information pertaining to data traffic groups and performance parameters. For example, the UE may provide information such as GER, latency information, packet importance, composition of the data traffic group, a number of remaining packets, packet size, etc. This information may allow the base station to make intelligent decisions regarding data traffic group handling, such as those outlined above. For example, the UE may request additional transmit resources from the base station, based on traffic in the UE’s transmit buffer, but may also provide to the base station intelligent information, such as latency requirements and a number of remaining packets. In response, the base station may determine that too little time remains within the latency budget to accommodate transmission of all remaining packets of the data traffic group. The base station may therefore forego allocating the requested additional transmit resources to the UE, or may perform some other intelligent action, based on the received information.

In some scenarios, various traffic information may be provided by the UE to the base station in a MAC control element (CE) of a physical uplink shared channel (PUSCH). The traffic information may pertain to an associated data traffic group. For example, the MAC CE may include an identifier of the data traffic group and/or of one or more packets included in the data traffic group. FIG. 6 illustrates an example of two PUSCH transmissions as time progresses from left to right. PUSCH-1 is transmitted in Slot n, and includes a first MAC CE containing traffic information. PUSCH-2 is transmitted in subsequent Slot m, and includes a second MAC CE containing traffic information.

According to current standards, each PUSCH may be scheduled at a different position within its respective slot, independent of the relative positions of PUSCHs in other slots. For example, in the scenario illustrated in FIG. 6, PUSCH-2 is transmitted at the start of Slot m, e.g., beginning in the first symbol of Slot m, while PUSCH-1 is transmitted at a time other than the start of Slot n, e.g., beginning in a symbol later than the first symbol of slot n. Assuming an SCS of 15 kHz, this may result in variations of start times within various slots of up to about 12/14 × 1 ms = 0.85 ms. The position of the PUSCH may be determined by the base station at the PHY layer, and may depend on various factors, such as whether other UL communications (e.g., from another UE) are given priority in earlier symbols within the slot.

Some traffic information, such as a latency information, may include and/or depend upon certain timing information. For example, traffic information included in a MAC CE may include an amount of time to be used as a latency requirement for the associated data traffic group and/or the amount of time remaining until the end of the latency period. The amount of time may be measured starting from some reference time known to both the UE and the base station. In some implementations, the reference time may be the start time of the PUSCH containing the MAC CE that includes the latency information. However, in some scenarios, this may lead to increased complexity because the MAC CE is written at the MAC level, while the PUSCH position is subsequently determined at the PHY level. For example, if the expected position of the PUSCH changes after the MAC CE is written, then the UE may need to return the data to the MAC level to modify the MAC CE with updated timing information, based on the changed start time of the PUSCH. To avoid this, in some implementations the reference time may be the start time of the slot containing the PUSCH, rather than the start of the PUSCH itself.

In some scenarios, similar traffic information may be carried in a MAC CE of a PDSCH, with similar timing considerations.

In some scenarios, similar traffic information may be carried in a MAC CE for downlink traffic, with similar timing considerations.

In some scenarios, various traffic information may be provided by the UE to the base station as uplink control information (UCI) within a physical uplink control channel (PUCCH). The traffic information may pertain to an associated data traffic group, and may include an identifier of the data traffic group and/or of one or more packets included in the data traffic group. FIG. 7 illustrates an example of two PUCCH transmissions as time progresses from left to right. PUCCH-1 is transmitted in Slot n, and includes first UCI containing traffic information. PUCCH-2 is transmitted in subsequent Slot m, and includes second UCI containing traffic information.

As with the PUSCH, each PUCCH may be scheduled at a different position within its respective slot, independent of the relative positions of PUCCHs in other slots. For example, in the scenario illustrated in FIG. 7, PUCCH-2 is transmitted at the start of Slot m, e.g., beginning in the first symbol of Slot m, while PUCCH-1 is transmitted at a time other than the start of Slot n, e.g., beginning in a symbol later than the first symbol of slot n.

As discussed previously, some traffic information, such as a latency information, may include and/or depend upon certain timing information. For example, traffic information included in the UCI may include an amount of time to be used as a latency requirement for the associated data traffic group and/or the amount of time remaining until the end of the latency period. The amount of time may be measured starting from some reference time known to both the UE and the base station. In some implementations, the reference time may be the start time of the PUCCH containing the UCI that includes the latency information, or may be the start time of the slot containing the PUCCH. Because the UCI is written by the PHY layer, using the start of the PUCCH as the reference time does not raise the same concerns as using the start of the PUSCH. On the other hand, resources in the PUCCH are more limited than in the PUSCH, which may lead to a desire to minimize the size of the UCI data provided for traffic information. It may be observed that reporting an amount of time relative to the start of the PUCCH may require a smaller field than reporting a longer amount of time relative to the start of the slot. Therefore, in some scenarios, using the start of the PUCCH as the reference time may be preferable.

In some implementations, the reference time may be the start time of a sub-slot within which a PUCCH starts. If the PUCCH includes repetitions, then the first repetition, e.g., the start time of a sub-slot within which a PUCCH’s first repetition starts, may be used as the reference time.

In some scenarios, similar traffic information may be carried in a DCI of a PDCCH, with similar timing considerations.

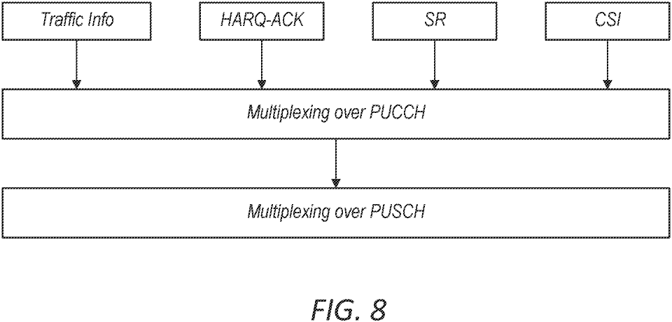

### FIGS. 8-10 – Multiplexing Data Group Traffic Information

In some scenarios, a UCI carrying traffic information pertaining to one or more data group may be scheduled for transmission at a time overlapping (e.g., within a same slot or subslot) with a UCI carrying one or more other UCIs, such as HARQ-ACK, scheduling request (SR), or channel state information (CSI). FIG. 8 illustrates a block diagram representing the handling of the UCIs in such a scenario, according to some embodiments.

As illustrated in FIG. 8, the overlapping UCIs may be multiplexed over a single PUCCH. According to some implementations, one or more lower-priority UCI(s) may be dropped (e.g., omitted from the resulting PUCCH), e.g., if PUCCH resources are insufficient to include all of the overlapping UCIs.

In some scenarios, the resulting PUCCH may be scheduled for transmission at a time overlapping with a PUSCH. In response, the UCIs may be further multiplexed to be carried over the PUSCH. In some such scenarios, the SR UCI (if present) will be discarded, as SR is not presently supported in PUSCH.

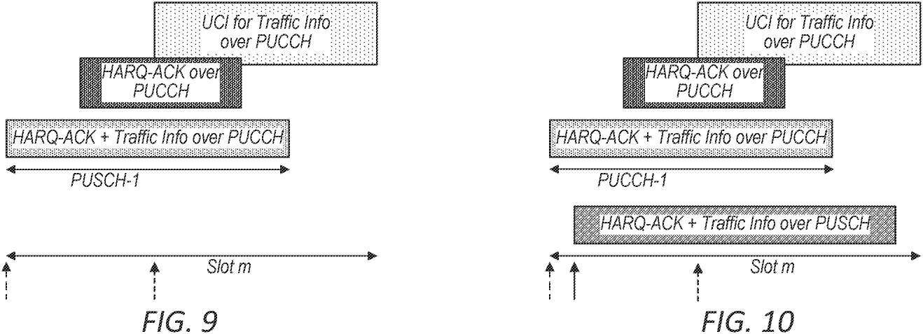

FIG. 9 illustrates an example of a UCI for traffic information that overlaps in time with a UCI for HARQ-ACK within Slot m, according to some embodiments. In response, the UE may multiplex the two UCIs for transmission over PUSCH-1. PUCCH-1 is transmitted in Slot m, and includes multiplexed traffic information and HARQ-ACK information.

In some such scenarios, the traffic information may include and/or depend upon certain timing information, which may be measured starting from a reference time known to both the UE and the base station, e.g., as discussed above. In some implementations, the reference time may be the start of Slot m. In other implementations, the reference time may be the start of the PUCCH. In yet other implementations, the reference time may be the time at which the UCI carrying the traffic information was scheduled for transmission prior to multiplexing. The latter option may, in some scenarios, be preferable for the reasons discussed in connection with FIG. 7.

In some scenarios, similar traffic information pertaining to a data traffic group may be carried in a DCI, e.g., carried in one or more DCI field(s) or mapped to one or more code states in the DCI, and carried in a PDCCH, with similar timing considerations.

FIG. 10 illustrates an example of a UCI for traffic information that overlaps in time with a UCI for HARQ-ACK within Slot m, according to some embodiments. In this example, the two UCIs may be multiplexed to form PUCCH-1, e.g., as in FIG. 9. However, in the example of FIG. 10, PUCCH-1 overlaps in time with a PUSCH. As a result, the UE may further multiplex the UCIs to be carried over the PUSCH in Slot m. The PUSCH is transmitted in Slot m, and includes the multiplexed traffic information and HARQ-ACK information.

In some scenarios, the traffic information may include and/or depend upon certain timing information, which may be measured starting from a reference time known to both the UE and the base station. In some implementations, the reference time may be the start of Slot m. In other implementations, the reference time may be the start of the PUSCH. In yet other implementations, the reference time may be the time at which the UCI carrying the traffic information was scheduled for transmission prior to multiplexing. The latter option may, in some scenarios, be preferable for the reasons discussed in connection with FIG. 7.

In some scenarios, similar traffic information may be carried in a DCI, which may be multiplexed with HARQ-ACK information and carried in a PDSCH, with similar timing considerations.

### UCI Format for Traffic Information

In implementations in which traffic information pertaining to a data traffic group is carried in a PUCCH, the traffic information may represent a new UCI type. In some such implementations, a single PUCCH configuration may be defined to carry traffic information pertaining to one or more traffic flows. In other implementations, multiple PUCCH configurations may be defined for respective traffic flows. For example, a first PUCCH configuration may be defined for a video traffic flow, a second PUCCH configuration may be defined for an audio traffic flow, a third PUCCH configuration may be defined for a pose/control information traffic flow, etc.

A traffic information PUCCH configuration may include reporting of traffic information such as latency information, packet type importance, data traffic group composition, exact packet size, number of remaining packets, reliability target (such as GER), etc. As one example, a first PUCCH configuration may be defined for traffic information pertaining to a first (e.g., video) traffic flow. The first PUCCH configuration may include latency information, a reliability requirement, and a PUCCH priority level. A second PUCCH configuration may be defined for traffic information pertaining to a second (e.g., audio) traffic flow. The second PUCCH configuration may include latency information, and a PUCCH priority level, but may omit a reliability requirement. The second traffic flow may be assumed to utilize a default reliability requirement. Numerous other configurations are also possible.

If multiple PUCCH configurations are defined for respective traffic flows, then PUCCH collisions may sometimes occur, in which PUCCHs for multiple traffic flows may be prepared for transmission at the same time or overlapping times. In some scenarios, the available PUCCH resources may be insufficient to accommodate all prepared PUCCHs. In such scenarios, the UE may prioritize some traffic information over other traffic information. The prioritized traffic information may be multiplexed and transmitted over the available PUCCH resources, while the lower-priority traffic information may be omitted, e.g., discarded.

As one example, the PUCCH associated with each traffic flow may include a priority index, indicating a relative priority of the traffic information included in that PUCCH. For example, a first PUCCH may be associated with a first traffic flow, which may be deemed to be of particularly high importance and/or which may be expected to most frequently deviate from default traffic information values. As a result, the first PUCCH may be assigned a greatest priority, e.g., priority index 0. A second PUCCH may be associated with a second traffic flow, which may be deemed to be of lower importance and/or which may be expected to rarely deviate from default traffic information values. As a result, the second PUCCH may be assigned a lower priority, e.g., priority index 1. In some implementations, additional, lower-priority values may also be defined, to allow greater differentiation in relative priority values. In some implementations, an index or other identification of the PUCCH resource configuration for traffic information may be used in the prioritization. For example, a lower-index PUCCH resource configuration for traffic information may have a higher priority than a higher-index PUCCH resource configuration for traffic information, or vice versa.

If a PUCCH collision occurs in a scenario utilizing such priority indexes, the UE may prioritize which information to transmit in the available PUCCH resources based on the respective priority indexes of the prepared PUCCHs. For example, the first PUCCH may be included first, based on the included priority index of 0. If PUCCH resources remain available after accommodating the first PUCCH, then some or all of the second PUCCH may be included, e.g., until all available PUCCH resources have been utilized, or until all prepared PUCCHs have been included. Any prepared PUCCH, or portion thereof, not included in the available PUCCH resources may be omitted, e.g., discarded.

As a second example, instead of (or in addition to) assigning a respective priority index to each prepared PUCCH, the UE may prioritize traffic information based on information type. For example, in some implementations, the UE may prioritize latency information most highly, and may prioritize a reliability requirement less highly. As a result, the UE may first include latency information from all prepared PUCCHs, and may then utilize any remaining PUCCH resources to include reliability requirements from some or all of the prepare PUCCHs. If PUCCH resources remain after including reliability requirements from all prepared PUCCHs, then the UE may use the remaining PUCCH resources to include some or all additional, lower-priority types of traffic information. Any traffic information not included in the available PUCCH resources may be omitted, e.g., discarded.

### Periodicity of Traffic Information Reporting

In some implementations, the base station may configure periodic reporting of traffic information by the UE, e.g., according to any of the preceding methods. For example, the base station may configure periodic PUCCH resources for the UE to report traffic information pertaining to data traffic groups. The periodic resources may be associated with a period and offset for a given XR traffic flow. In some implementations, the base station may configure different periodic PUCCH resources for different traffic flows.

If the downlink traffic arriving at the base station is encrypted, the base station may be unable to inspect the downlink traffic to decide on the number of periodic configurations to configure at the UE. As a result, the base station may utilize assistance information from the UE or from the core network to facilitate the base station’s choice of configurations at the UE.

If the uplink traffic arriving at the base station is encrypted, the base station may be unable to inspect the uplink traffic to decide on the number of periodic configurations to configure at the UE. It may be observed that the UE holds more information about uplink traffic than the base station. Therefore, then base station may utilize assistance information from the UE or from core network to facilitate the base station’s choice of configurations at the UE.

As one example, downlink XR traffic may include a video stream, an audio stream, and a data stream, which arrive with different periodicities and separate offsets with respective streams’ periodicities. The UE may report to the base station the number of XR traffic flows and their characteristics from UE’s dialogue with the application server and/or core network. Alternatively, or additionally, the base station may acquire such information from the session management function (SMF) of the core network. With the information acquired through either or both means, the base station may configure periodic PUCCH resources for each DL traffic stream to facilitate the UE’s reporting of XR traffic information.

In some implementations, the base station may configure semi-persistent (SP) reporting by the UE, wherein the base station may provide an indication to activate/deactivate periodic reporting. SP reporting of traffic information, which may include downlink traffic information and/or uplink traffic information, may be carried over PUCCH or PUSCH. In some scenarios, the network may configure SP reporting of traffic information with both PUCCH and PUSCH. As discussed above, traffic information for one or more traffic flow may be carried in a single SP reporting configuration or in multiple SP reporting configurations.

As a first example, a new MAC CE may be introduced to trigger the UE to report traffic information on PUCCH resources with SP reporting. The triggering may be linked with a periodicity and an offset, and with the PUCCH resource associated with the reporting.

As a second example, a new trigger state field may be introduced in a downlink control information (DCI) transmission, to trigger the UE to report traffic information on PUSCH resources with SP reporting. The triggering may be linked with a periodicity and an offset, and with the PUSCH resource associated with the reporting.

In some implementations, semi-persistent configuration of PUSCH may also be used for CSI reporting. If SP CSI reporting and SP traffic information reporting occur on different PUSCHs, then the transmission time for both may be long. Power-efficiency may therefore be improved by supporting reporting of SP CSI reporting and SP traffic information reporting on the same PUSCH. For example, the existing mechanism for SP CSI triggering may be expanded to support both CSI and traffic information. As another example, SP traffic information carried over PUSCH may be separately triggered, and may be multiplexed with SP CSI reporting. This may allow the network more flexibility in choosing different periodicities and offsets for SP CSI and SP traffic information. E.g., if there is overlap between a first PUSCH carrying SP CSI and a second PUSCH carrying SP traffic information on the same component carrier, then both the SP CSI and the SP traffic information may be carried over the first PUSCH. Alternatively, both the SP CSI and the SP traffic information may be carried over the second PUSCH. If the PUSCH selected to carry both the SP CSI and the SP traffic information includes insufficient resources to accommodate both information sets, then low priority data may be omitted, e.g., discarded. For example, if either the SP CSI or the SP traffic information is deemed to be lower priority, then some or all of that data set may be omitted. Alternatively, lower-priority data from both data sets may be omitted.

In some implementations, the base station may configure resources and trigger aperiodic reporting by the UE. For example, the base station may first configure trigger states and associated traffic information for one or more traffic flows having a trigger, e.g., with RRC signaling and/or MAC CE. MAC CE may be used to narrow the addressable traffic information requests among configurations by RRC signaling. Subsequently, the network may provide an indication, e.g., in a downlink control information (DCI) transmission, for the UE to report traffic information, e.g., in a PUCCH or PUSCH. In some implementations, the indication may specify one or more of a plurality of traffic flows for which the UE should provide traffic information. For example, the base station may transmit a DCI including a 4-bit traffic information trigger state field, which may indicate any of up to 16 different configurations of UE traffic flows for which traffic information should be reported. Other formats are also possible for triggering aperiodic reporting of traffic information.

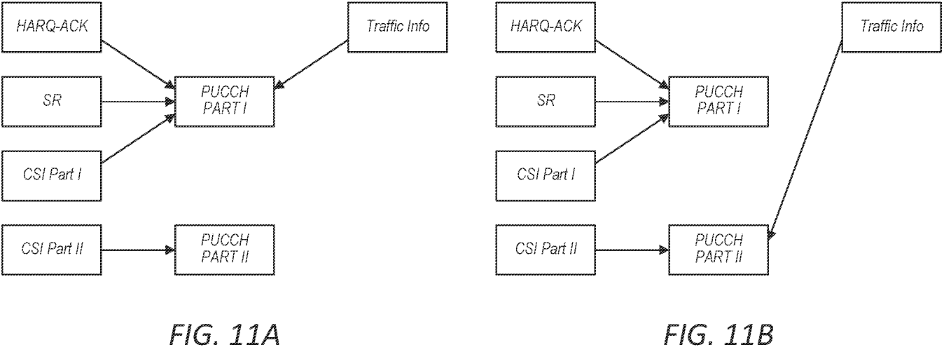

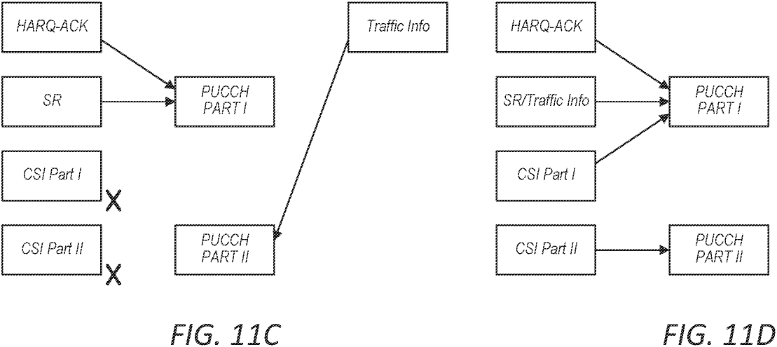

### FIGS. 11-14 – Example PUCCH Multiplexing Configurations

FIGS. 11-14 illustrate block diagrams representing various configurations by which a UCI carrying traffic information pertaining to one or more data groups may be multiplexed with one or more other UCI(s) for transport on a PUCCH, according to some embodiments. In some implementations, one or more UCI types may include priority levels, while in other implementations, no priority distinctions are made. In some implementations, the traffic information UCI may be a single-part UCI, while in other implementations the traffic information UCI may be a two-part UCI.

FIGS. 11A-11D illustrate block diagrams representing four different example multiplexing configurations in which the traffic information UCI is a single-part UCI and no priority distinctions are made within any of the UCI types, according to some embodiments.

FIG. 11A illustrates each of five UCI types: Traffic Information, HARQ-ACK, SR, CSI Part I, and CSI Part II. Two or more of these UCIs may be multiplexed into a PUCCH, e.g., as discussed in connection with FIG. 8. As illustrated, the PUCCH may include PUCCH Part I and PUCCH Part II, e.g., as known in the art. For example, existing 3GPP standards allow for HARQ-ACK, SR, and/or CSI Part I to be carried in PUCCH Part I, while CSI Part II (if present) may be carried within PUCCH Part II. If more than one UCI is to be carried in PUCCH Part I, the payloads of such UCIs may be concatenated and encoded by a first encoder. CSI Part II may be encoded by a second encoder. In the example illustrated by FIG. 11A, Traffic Information may also be concatenated with the other UCIs of PUCCH Part I, and encoded by the first encoder. In various implementations, Traffic Information may be concatenated at various points, relative to the other UCIs. For example, the Traffic Information may be concatenated between HARQ-ACK and SR, or between SR and CSI Part I, or after CSI Part I. It should be understood that less than all of the illustrated UCIs may be present in any particular scenario. Less than all of the illustrated UCIs may be present in an applicable specification, to simplify the support of traffic information reporting. FIG. 11A illustrates how each UCI type may be handled if present.

FIG. 11B illustrates a similar example, except that Traffic Information may be carried in PUCCH Part II. For example, Traffic Information may be concatenated with CSI Part II and encoded by the second encoder. The ordering of UCIs within a PUCCH part may be according to their importance/priority. For example, CSI Part II may be appended to Traffic Information in FIG. 11B, as Traffic Information may be considered more important. Similar considerations regarding ordering of UCIs may be applied to other scenarios, such as those illustrated in any of FIGS. 11-15.

FIG. 11C illustrates an example in which CSI Part I and CSI Part II are dropped (e.g., omitted) when Traffic Information is present. For example, in some implementations, Traffic Information may be deemed to be more important than CSI, such that CSI may be dropped to ensure sufficient resource availability in the PUCCH to include Traffic Information. Traffic Information may be encoded by the second encoder and carried in PUCCH Part II.

FIG. 11D illustrates an example in which Traffic Information is treated as an extension of SR. It may be observed that a Traffic Information UCI may reflect many similarities to an SR UCI, such that treating Traffic Information and SR together during UCI multiplexing may be logical. In the example of FIG. 11D, Traffic Information may assume the place of SR, if no SR UCI is present, or may be prepended/appended/concatenated to SR, if SR is present. In some implementations, Traffic Information may provide finer information about applicable data traffic than SR, so Traffic Information may be prioritized over SR, if SR is present. For example, if both SR and Traffic Information are present, SR may be dropped. In some implementations, dropping of SR may occur only if the Traffic Information present is for uplink.

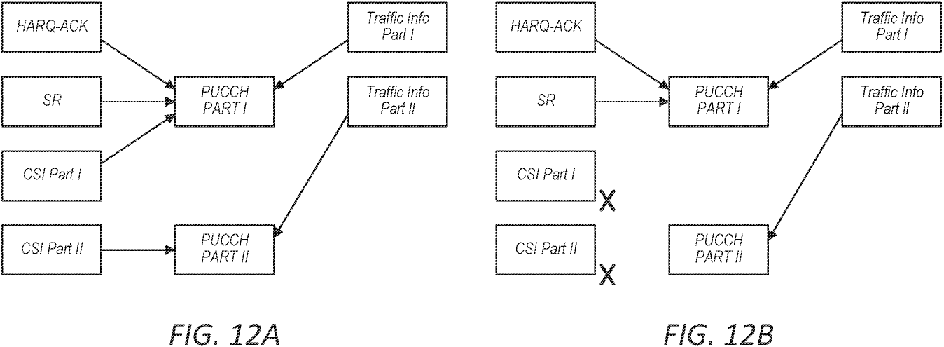

FIGS. 12A-12B illustrate block diagrams representing two different example multiplexing configurations in which the traffic information UCI is a two-part UCI and no priority distinctions are made within any of the UCI types, according to some embodiments.

FIG. 12A illustrates an example similar to FIG. 11A, except that the Traffic Information UCI is illustrated in two parts: Traffic Information Part I and Traffic Information Part II. In some implementations, Traffic Information Part II may carry the Traffic Information payload, while Traffic Information Part I may indicate the size of Traffic Information Part II, e.g., in bits. As illustrated, Traffic Information Part I may be carried in PUCCH Part I (e.g., concatenated with HARQ-ACK, SR, and/or CSI Part I, if present, and encoded by the first encoder), while Traffic Information Part II may be carried in PUCCH Part II (e.g., concatenated with CSI Part II, if present, and encoded by the second encoder).

FIG. 12B illustrates a similar example, except that CSI Part I and CSI Part II are dropped when Traffic Information is present, similar to the example of FIG. 11C.

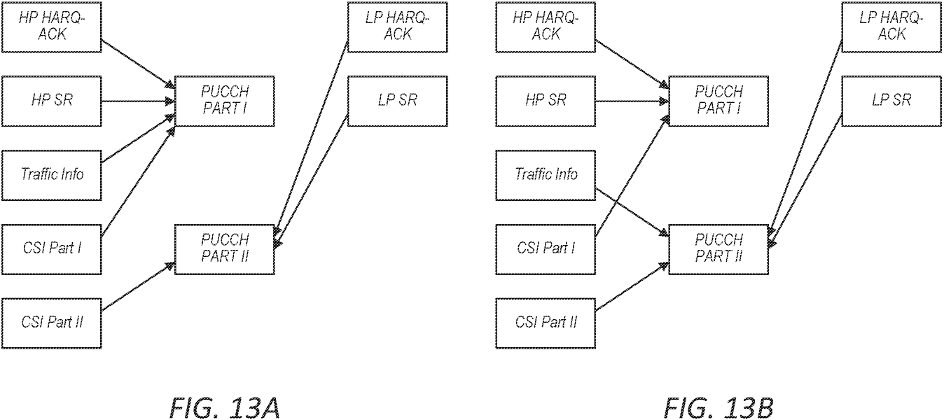

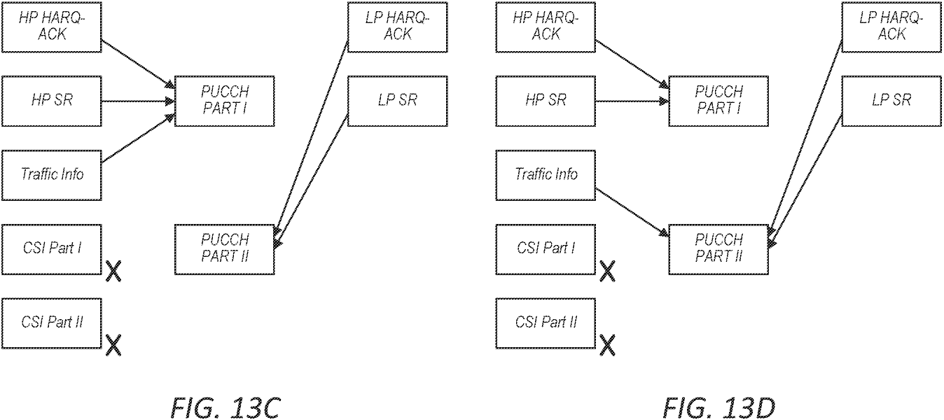

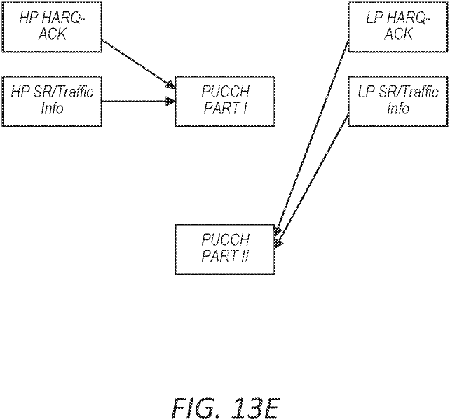

FIGS. 13A-13E illustrate block diagrams representing five different example multiplexing configurations in which the traffic information UCI is a single-part UCI and priority distinctions are made within some of the UCI types, according to some embodiments. Specifically, as illustrated, a HARQ-ACK UCI may be either high-priority (HP) HARQ-ACK or low-priority (LP) HARQ-ACK. Similarly, an SR UCI may be HP SR or LP SR. Existing 3GPP standards allow for LP HARQ-ACK and/or LP SR to be carried in PUCCH Part II (e.g., concatenated with CSI Part II, if present, and encoded by the second encoder).

FIG. 13A illustrates an example in which Traffic Information is added to such a configuration, and may be carried in PUCCH Part I.

FIG. 13B illustrates a similar example, in which Traffic Information may be carried in PUCCH Part II.

FIG. 13C illustrates an example similar to that of FIG. 13A, except that CSI Part I and CSI Part II are dropped when Traffic Information is present.

FIG. 13D illustrates an example similar to that of FIG. 13B, except that CSI Part I and CSI Part II are dropped when Traffic Information is present.

FIG. 13E illustrates an example in which Traffic Information is treated as an extension of SR, similar to the example of FIG. 11D.

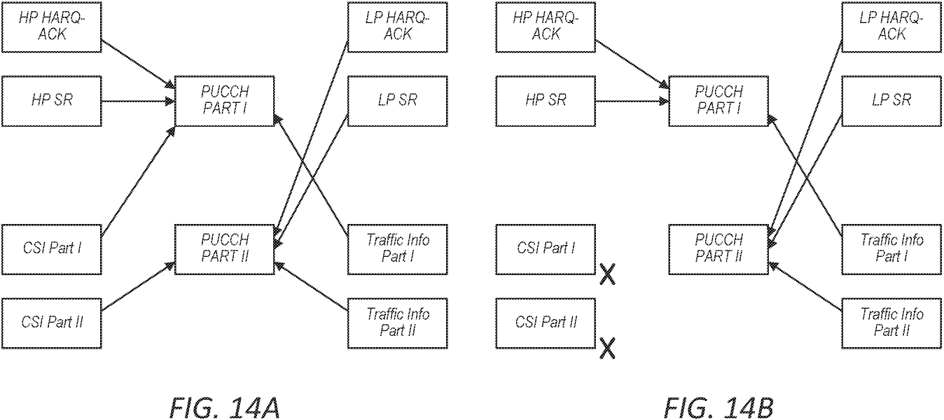

FIGS. 14A-14B illustrate block diagrams representing two different example multiplexing configurations in which the traffic information UCI is a two-part UCI and priority distinctions are made within some of the UCI types, according to some embodiments.

FIG. 14A illustrates an example similar to FIG. 13A, except that the Traffic Information UCI is illustrated in two parts. As illustrated, Traffic Information Part I may be carried in PUCCH Part I, while Traffic Information Part II may be carried in PUCCH Part II.

FIG. 14B illustrates a similar example, except that CSI Part I and CSI Part II are dropped when Traffic Information is present.

Any of the preceding configurations, or similar configurations, may be used in various implementations to multiplex UCIs for transmission within a PUCCH. For example, a UE, such as the UE 106, or some component thereof, such as the radio 330 or the cellular controller 354, may perform UCI encoding according to any of the preceding configurations. A base station, such as the base station 102, or some component thereof, such as the radio 430, may decode a PUCCH configured according to any of the preceding configurations.

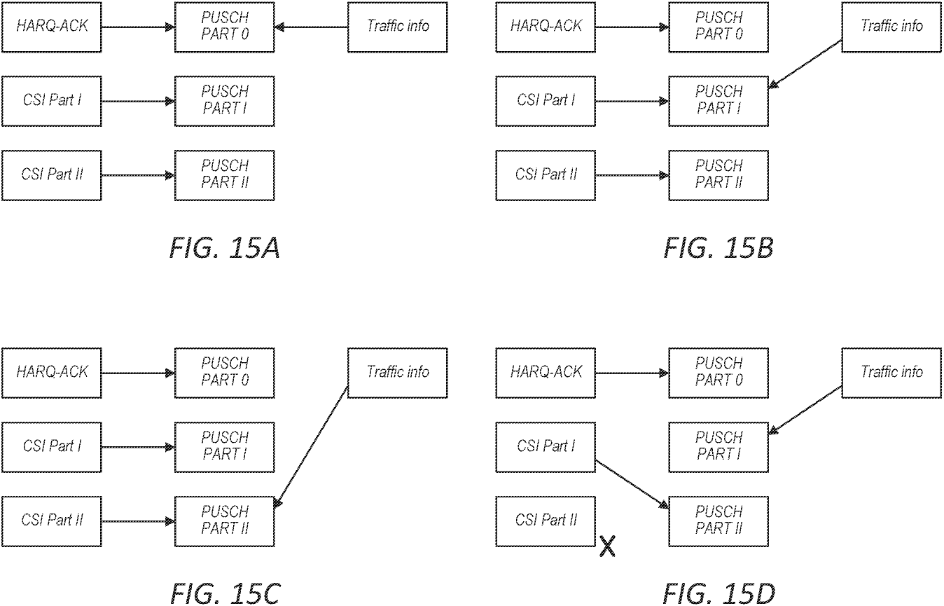

### FIGS. 15-18 – Example PUSCH Multiplexing Configurations

FIGS. 15-18 illustrate block diagrams representing various configurations by which a UCI carrying traffic information pertaining to one or more data groups may be multiplexed with one or more other UCI(s) for transport on a PUSCH, according to some embodiments. In some implementations, one or more UCI types may include priority levels, while in other implementations, no priority distinctions are made. In some implementations, the traffic information UCI may be a single-part UCI, while in other implementations the traffic information UCI may be a two-part UCI.

FIGS. 15A-15D illustrate block diagrams representing four different example multiplexing configurations in which the traffic information UCI is a single-part UCI and no priority distinctions are made within any of the UCI types, according to some embodiments.

FIG. 15A illustrates each of four UCI types: Traffic Information, HARQ-ACK, CSI Part I, and CSI Part II. Two or more of these UCIs may be multiplexed into a PUSCH, e.g., as discussed in connection with FIG. 8. As illustrated, the PUSCH may include PUSCH Part 0, PUSCH Part I, and PUSCH Part II, e.g., as known in the art. For example, existing 3GPP standards allow for HARQ-ACK to be carried in PUSCH Part 0 and encoded by a first encoder. CSI Part I may be carried in PUSCH Part I and encoded by a second encoder. CSI Part II may be carried in PUSCH Part II and encoded by a third encoder. In the example illustrated by FIG. 15A, Traffic Information may also be included in PUSCH Part 0. If HARQ-ACK is also present, then Traffic Information may be concatenated therewith, and encoded by the first encoder. It should be understood that less than all of the illustrated UCIs may be present in any particular scenario. Less than all of the illustrated UCIs may be present in an applicable specification, to simplify the reporting of traffic information. FIG. 15A illustrates how each UCI type may be handled if present.

FIG. 15B illustrates a similar example, except that Traffic Information may be carried in PUSCH Part I. For example, Traffic Information may be concatenated with CSI Part I and encoded by the second encoder.

FIG. 15C illustrates a similar example, except that Traffic Information may be carried in PUSCH Part II. For example, Traffic Information may be concatenated with CSI Part II and encoded by the third encoder.

FIG. 15D illustrates an example similar to FIG. 15B, in which Traffic Information may be carried in PUSCH Part I, except that in FIG. 15D, CSI Part I may be moved, so as to be carried in PUSCH Part II, e.g., so as to ensure sufficient resource availability in PUSCH Part I for Traffic Information. CSI Part II may be dropped.

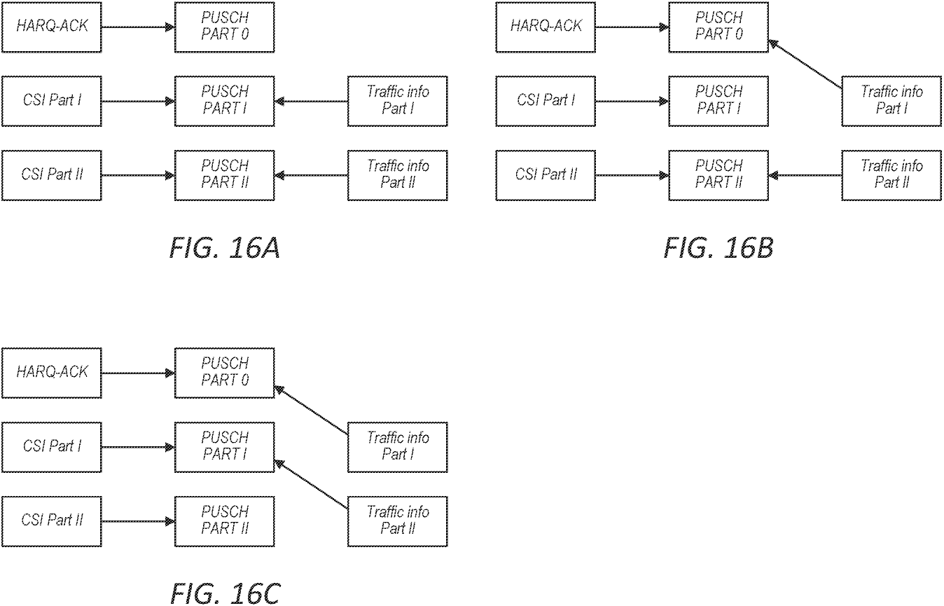

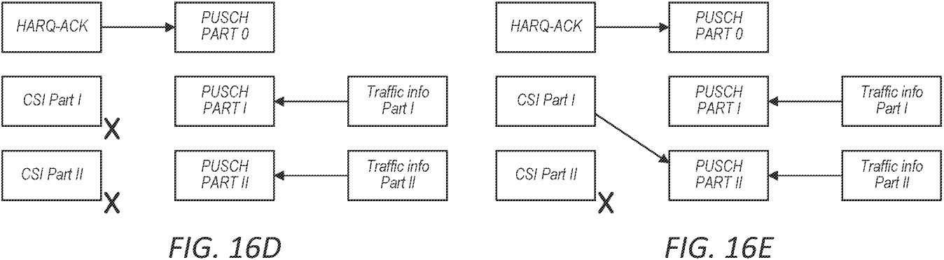

FIGS. 16A-16E illustrate block diagrams representing five different example multiplexing configurations in which the traffic information UCI is a two-part UCI and no priority distinctions are made within any of the UCI types, according to some embodiments.

FIG. 16A illustrates an example similar to FIG. 15A, except that the Traffic Information UCI is illustrated in two parts: Traffic Information Part I and Traffic Information Part II. In some implementations, Traffic Information Part II may carry the Traffic Information payload, while Traffic Information Part I may indicate the size of Traffic Information Part II, e.g., in bits. As illustrated, Traffic Information Part I may be carried in PUSCH Part I (e.g., concatenated with CSI Part I, if present, and encoded by the second encoder), while Traffic Information Part II may be carried in PUSCH Part II (e.g., concatenated with CSI Part II, if present, and encoded by the third encoder).

FIG. 16B illustrates a similar example, except that Traffic Information Part I may be carried in PUSCH Part 0 (e.g., concatenated with HARQ-ACK, if present, and encoded by the first encoder).

FIG. 16C illustrates an example similar to FIG. 16B, except that Traffic Information Part II may be carried in PUSCH Part I (e.g., concatenated with CSI Part I, if present, and encoded by the second encoder).

FIG. 16D illustrates an example similar to FIG. 16A, except that CSI Part I and CSI Part II may be dropped when Traffic Information is present.

FIG. 16E illustrates an example similar to FIG. 16A, except that CSI Part I may be moved, so as to be carried in PUSCH Part II, and CSI Part II may be dropped.

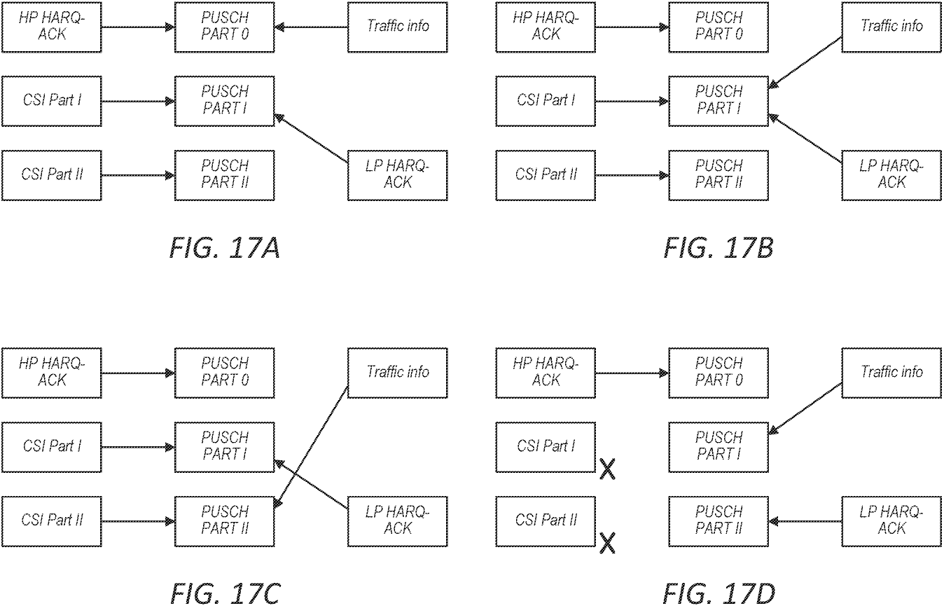

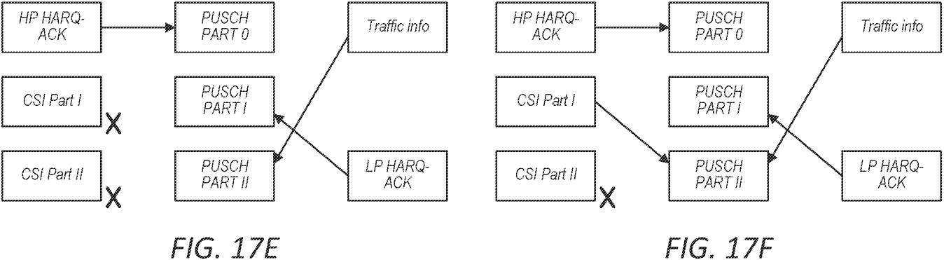

FIGS. 17A-17F illustrate block diagrams representing six different example multiplexing configurations in which the traffic information UCI is a single-part UCI and priority distinctions are made within some of the UCI types, according to some embodiments. Specifically, as illustrated, a HARQ-ACK UCI may be either high-priority (HP) HARQ-ACK or low-priority (LP) HARQ-ACK. Existing 3GPP standards allow for LP HARQ-ACK to be carried in PUSCH Part I (e.g., concatenated with CSI Part I, if present, and encoded by the second encoder).

FIG. 17A illustrates an example in which Traffic Information is added to such a configuration, and may be carried in PUSCH Part 0.

FIG. 17B illustrates a similar example, in which Traffic Information may be carried in PUSCH Part I.

FIG. 17C illustrates a similar example, in which Traffic Information may be carried in PUSCH Part II.

FIG. 17D illustrates a similar example, except that CSI Part I and CSI Part II may be dropped when Traffic Information is present. Traffic Information may be carried in PUSCH Part I, ad LP HARQ-ACK may be carried in PUSCH Part II.

FIG. 17E illustrates an example similar to FIG. 17D, except that Traffic Information may be carried in PUSCH Part II, while LP HARQ-ACK remains in PUSCH Part I.

FIG. 17F illustrates an example similar to FIG. 17A, except that CSI Part II is dropped in the presence of Traffic Info. CSI Part I and/or Traffic Info may be carried in PUSCH Part II, while LP HARQ-ACK remains in PUSCH Part I.

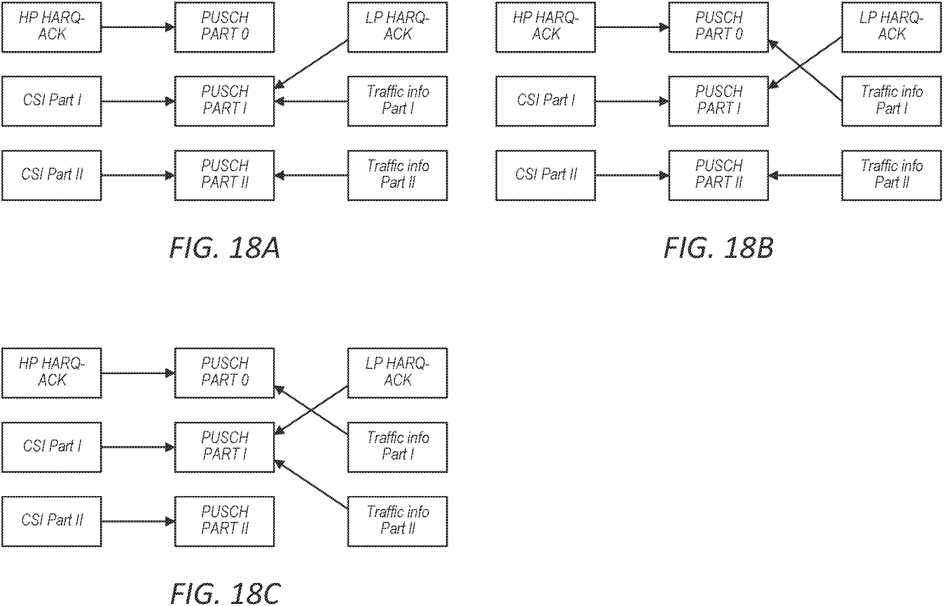

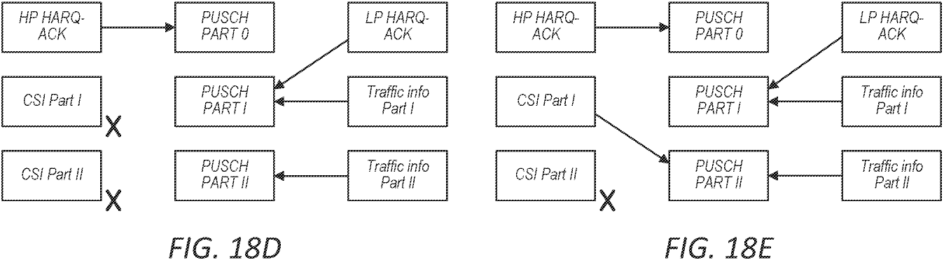

FIGS. 18A-18E illustrate block diagrams representing five different example multiplexing configurations in which the traffic information UCI is a two-part UCI and priority distinctions are made within some of the UCI types, according to some embodiments.

FIG. 18A illustrates an example Similar to FIG. 17A, except that the Traffic Information UCI is illustrated in two parts. Traffic Information Part I may be carried in PUSCH Part I, and Traffic Information Part II may be carried in PUSCH Part II.

FIG. 18B illustrates a similar example, except that Traffic Information Part I may be carried in PUSCH Part 0.

FIG. 18C illustrates a similar example, except that Traffic Information Part I may be carried in PUSCH Part 0 and Traffic Information Part II may be carried in PUSCH Part I.

FIG. 18D illustrates an example similar to FIG. 18A, except that CSI Part I and CSI Part II are dropped when Traffic Information is present.

FIG. 18E illustrates an example similar to FIG. 18A, except that CSI Part II is dropped when Traffic Information is present, and CSI Part I may be carried in PUSCH Part II.

Any of the preceding configurations, or similar configurations, may be used in various implementations to multiplex UCIs for transmission within a PUSCH. For example, a UE, such as the UE 106, or some component thereof, such as the radio 330 or the cellular controller 354, may perform UCI encoding according to any of the preceding configurations. A base station, such as the base station 102, or some component thereof, such as the radio 430, may decode a PUSCH configured according to any of the preceding configurations.

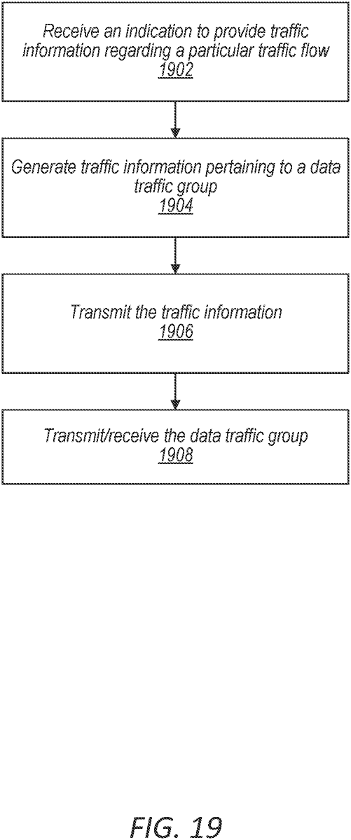

### FIG. 19 – Example Method

FIG. 19 is a flow chart diagram illustrating a method for providing traffic information pertaining to a data traffic group, according to some embodiments. The method of FIG. 19 may be performed by a UE, such as the UE 106, or by some component thereof, such as by the radio 330 and/or the cellular controller 354. As shown, the method of FIG. 19 may operate as follows.

At 1902, the UE 106 may receive, from a base station, an indication to provide traffic information regarding a particular traffic flow. For example, the traffic flow may include data from a particular application being executed on the UE 106, such as data pertaining to a particular class or type of data. As a specific example, the data flow may include video traffic from the application. As another example, the data flow may contain audio traffic or control traffic, etc.

In some scenarios, the traffic flow may include uplink traffic generated by the UE for (and/or by) the application. In some scenarios, the traffic flow may include downlink traffic about which the UE has knowledge, but which is generated by a remote device, such as another UE or a network XR server.

In some scenarios, the indication may include a trigger to report aperiodic traffic information for one or more traffic flows. In some scenarios, the indication may include an instruction and/or configuration information to perform periodic reporting of traffic information for one or more traffic flows. For example, the indication may indicate periodic resources for reporting the traffic information and/or may indicate one or more parameters, such as a period and/or time offset value for reporting. In some scenarios, the indication may include an indication to perform semi-persistent reporting. For example, the indication may include an instruction to temporarily activate periodic reporting.

In some scenarios, the indication to provide traffic information may represent a generic indication for the UE to provide traffic information, e.g., without identifying a particular traffic flow. In such scenarios, the UE may identify one or more particular traffic flow(s) for which to provide the traffic information.

At 1904, in response to receiving the indication to provide traffic information, the UE 106 may generate traffic information pertaining to a data traffic group of the particular traffic flow. The data traffic group may include uplink data from the application or downlink data directed to the application. For example, the data traffic group may include a plurality of packets including at least a minimum quantity of data needed for the application to perform a single function, such as a minimum quantity of video data needed for the application to encode a video frame, or a discrete portion of a video frame.

The traffic information may include information regarding the nature, status, performance, and/or constraints of the data traffic group. For example, the traffic information may include the size and/or composition of the packets in the data traffic group, the number of packets remaining in the data traffic group, a priority level indication of the packets of the data traffic group, a reliability requirement of the data traffic group, a maximum group error rate of the data traffic group, latency information pertaining to the data traffic group, etc. In some scenarios, latency information, such as time remaining in a defined latency window within which transmission of the data traffic group should (or must) be completed, may be measured from a reference time. For example, the reference time may be the start of a slot in which the traffic information is transmitted. As another example, the reference time may be the start of a symbol in which begins a PUCCH or PUSCH that carries the traffic information.

In some scenarios, generating the traffic information may include generating at least one UCI including the traffic information.

In some scenarios, the generated traffic information may include traffic information for more than one data traffic group and/or more than one traffic flow. For example, in some scenarios utilizing periodic or SP scheduling, the UE may generate traffic information pertaining to the particular traffic flow, generally, without including traffic information specific to a particular data traffic group. It should be understood that such traffic information nevertheless pertains to the data traffic group noted at 1904, as that data traffic group is included in the particular traffic flow.

At 1906, the UE 106 may transmit the generated traffic information. In some scenarios, the UE 106 may transmit the traffic information within a PUCCH, e.g., within a UCI encoded in the PUCCH. In some scenarios, the UE 106 may transmit the traffic information within a PUSCH, e.g., within a MAC CE of the PUSCH, or within a UCI multiplexed into the PUSCH. In some scenarios the UE 106 may generate additional UCIs (e.g., carrying traffic information for additional traffic flows or carrying other types of UCI data, such as HARQ-ACK, SR, and/or CSI) for transmission at a time overlapping the transmission time of a UCI carrying the traffic information. In such scenarios, the UE 106 may multiplex two or more of the UCIs to be transmitted in a single PUCCH or PUSCH. In some scenarios, the UE 106 may omit a portion of traffic information, such as low-priority information, and/or from one or more additional UCI(s) due to insufficient resources within a PUCCH or PUSCH to include all available UCIs. In some scenarios, the UE 106 may omit one or more of the additional UCIs from a PUCCH due to insufficient resources within the PUCCH to include all available UCIs. In some such scenarios, the UE 106 may select a UCI to omit based on a priority index of the UCI and/or based on a relative priority level of the UCI type. E.g., the UE may select a CSI UCI to be omitted because CSI reporting may be considered lower priority than traffic information reporting in some implementations.

At 1908, the UE 106 may transmit or receive the data traffic group. For example, if the data traffic group includes uplink traffic, then the UE may transmit the data traffic group, e.g., in response to appropriate scheduling and resource allocation by the base station. As another example, if the data traffic group includes downlink traffic, then the UE may receive the data traffic group, e.g., as transmitted by the base station. In some scenarios, the UE 106 may transmit/receive a plurality of data traffic groups as part of a traffic flow. In some scenarios, the UE 106 may transmit/receive a plurality of traffic flows, e.g., representing respective types or classes of data.

It should be understood that the preceding method is one example, and numerous variations are also envisioned. In some scenarios, one or more steps may be omitted or reordered, and/or additional steps may be added. For example, in some scenarios, 1902 may be omitted, e.g., where periodic reporting is preconfigured. As another example, transmitting/receiving the data traffic group at 1908 may include transmitting/receiving multiple packets, which occur in part before, during, and/or after transmitting the traffic information at 1906. In other words, the UE 106 may, in some scenarios, perform 1904-1906 multiple times throughout transmission/reception of the data traffic group at 1908. In some scenarios, 1908 may be omitted entirely, or transmission/reception of some portion of the data traffic group may be omitted, e.g., at the network’s discretion, such as according to the intelligent scheduling decisions outlined above.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method comprising:
by a user equipment (UE):
generating traffic information pertaining to a data traffic group including data from an application being executed on the UE; and
transmitting the traffic information to a base station.

2. The method of claim 1, further comprising:
by the UE:
transmitting the data traffic group, including a plurality of packets including at least a minimum quantity of data needed for the application to perform a single function.

3. The method of claim 2, wherein the minimum quantity of data constitutes a minimum quantity of video data needed for the application to encode a discrete portion of a video frame.

4. The method of claim 1, wherein transmitting the traffic information includes including the traffic information within a medium access control (MAC) control element (CE) within a physical uplink shared channel (PUSCH).

5. The method of claim 1, wherein the traffic information includes latency information to be measured from a reference time, wherein the reference time used is the start of a symbol in which begins a physical uplink shared channel (PUSCH) in which the traffic information is transmitted.

6. The method of claim 1, wherein generating the traffic information includes generating at least one uplink control information (UCI) including the traffic information.

7. The method of claim 6, wherein transmitting the traffic information includes including the UCI including the traffic information within a physical uplink control channel (PUCCH).

8. The method of claim 7, wherein the PUCCH further includes at least one additional UCI.

9. The method of claim 8, wherein the at least one additional UCI includes traffic information pertaining to a second data traffic group including a different class of data from the application.

10. The method of claim 9, wherein a portion of the traffic information is omitted from the UCI and the at least one additional UCI, due to insufficient resources within the PUCCH to include all available UCIs.

11. The method of claim 7, wherein at least one additional UCI is omitted from the PUCCH due to insufficient resources within the PUCCH to include all available UCIs.

12. The method of claim 11, wherein the at least one additional UCI is selected for omission based on a priority index included in the traffic information.

13. The method of claim 11, wherein the UCI omitted is selected based on a relative priority level of the UCI type.

14. The method of claim 1, wherein the traffic information includes latency information to be measured from a reference time, wherein the reference time used is the start of a symbol in which begins a physical uplink control channel (PUCCH) in which the traffic information is transmitted.

15. The method of claim 1, wherein the traffic information includes latency information to be measured from a reference time, wherein the reference time used is the start of a slot in which the traffic information is transmitted.

16. The method of claim 1, wherein the traffic information includes at least one of:
a reliability requirement of the data traffic group;
a priority level of the data traffic group;
a maximum group error rate of the data traffic group;
a number of remaining packets in the data traffic group;
packet size of one or more packets of the data traffic group; or
packet size of remaining packets in the data traffic group.

17. The method of claim 1, further comprising:
by the UE:
receiving, from the base station, an indication to provide traffic information regarding a particular traffic flow, wherein the data traffic group is included in the particular traffic flow, and wherein the generating the traffic information is in response to receiving the indication.

18. The method of claim 17, wherein the indication further indicates periodic resources for the UE to provide traffic information regarding the particular traffic flow.

19. An apparatus for providing traffic information pertaining to a data traffic group, the apparatus comprising:
memory, storing software instructions; and
at least one processor configured to execute the software instructions to cause the apparatus to:
generate traffic information pertaining to a data traffic group including data from an application being supported by the apparatus; and
output the traffic information for transmission to a base station.

20. A non-transitory computer-readable memory medium storing software instructions that, when executed by a processor of a user equipment (UE), cause the UE to:
generate traffic information pertaining to a data traffic group including data from an application being executed on the UE; and
transmit the traffic information to a base station.
